(19) United States
(12) Patent Application Publication
(10) Pub. No.: US 2002/0075003 A1
(43) Pub. Date: Jun. 20, 2002

(54) Adaptive battery charging based on battery condition

(75) Inventors: Anatoliy Fridman, Roswell, GA (US); Yury M. Podrazhansky, Norcross, GA (US)

Correspondence Address: TROUTMAN SANDERS LLP, BANK OF AMERICA PLAZA, SUITE 5200, 600 PEACHTREE STREET , NE, ATLANTA, GA, 30308-2216, US

(73) Assignee: Enrev Power Solutions, Inc., Norcross, GA (US)

(21) Appl. No.: 10/008,368

(22) Filed: Nov. 13, 2001

Related U.S. Application Data
(60) Provisional application No. 60/248,990, filed on Nov. 15, 2000.

(51) Int. Cl. G01N 27/416

(52) U.S. Cl. 324/426

(57) ABSTRACT

A test pulse having an amplitude (IP) and a duration (T) is applied to the battery. The battery voltages at the beginning (V1) and at the end (V2) of the test pulse are measured, and a difference voltage (ΔV) is determined. This difference voltage is used, either alone or along with the difference voltage for a new battery and a compensation factor, to determine the state of deterioration of the battery, the charge capacity of the battery, and/or the charging rate of the battery. The state of deterioration of a battery affects its charge capacity and its ability to accept a charge. A battery is best charged when its state of deterioration is considered. The charge capacity of the battery and the charging rate for charging the battery are therefore adjusted with respect to those parameters for a new battery based upon the state of deterioration of the battery.

### PRIORITY CLAIM

This application claims the priority of U.S. Provisional Patent Application No. 60/248,990 filed Nov. 15, 2000.

### FIELD OF THE INVENTION

The present invention relates to battery chargers and, more particularly, to a battery charger which determines the state of deterioration of a battery and automatically adapts or adjusts the charge process parameters in response to the state of deterioration.

### BACKGROUND OF THE INVENTION

Many portable devices, such as cellular phones, digital cameras, and laptop computers, use rechargeable batteries, which require periodic recharging by a battery charger. Depending upon the type of battery being recharged, a battery charger may provide a constant current or a constant voltage, or may switch between the two, depending upon the phase in the charging cycle. In addition, battery chargers may provide a steady current or voltage or may provide a pulsed current or voltage. One well known charging process for charging Lithium-ion batteries has a constant current phase for initially charging the battery, a constant voltage phase for topping off the charge, and a trickle charge or termination phase for maintaining the charge on the battery.

A limitation on charging techniques is that most users of rechargeable batteries do not want to wait for several hours for a battery to recharge. Therefore, rapid charging of batteries is also a requirement. One method of rapidly charging batteries, disclosed in U.S. Pat. No. 5,307,000, uses one or more high current charge pulses, followed by one or more high current discharge (depolarization) pulses, with rest periods interspersed throughout.

However, as a battery is used or “cycled” (discharged, and then recharged), the ability of the battery to accept the next charge decreases, or “fades”. Thus, after, for example, 100 cycles, a fully charged battery will have a lesser charge capacity than the same battery after only 1 cycle. This fading, or degradation in the charge capacity, results from several factors: gradual consumption of the electrodes and electrolyte, irreversible deterioration of the active materials, and spurious side electrochemical reactions. Further, and this is true for most if not all batteries, the greater the rate of charge or discharge, the faster the battery capacity fades. Thus, using a battery with a load that draws a high current, and then charging the battery with a high current, will increase the rate at which the battery capacity will fade. Thus, the degree of fading, or state of deterioration of a battery, determines the actual charge capacity of the battery. In addition, attempting to force a charge into a battery once it has reached its full charge capacity causes detrimental side effects which increases the rate at which the battery capacity will fade.

The actual or current charge capacity (C_{c}) of a battery can be expressed as:

C_{C}=αC₀,

where C₀ is the original capacity of the battery, and α is the fade factor and is not greater than one. For example, when α is one, the battery is new and C_{C} is equal to C₀; when α is 0.5, the battery is used and C_{C} is only one-half of the original capacity; and when α approaches zero, the battery is completely used up and C_{C} is essentially zero.

The actual charge capacity of a battery can also be expressed as:

C_{CN}=α_{N}C_{C(N-1)}

where C_{CN} is the current charge capacity of the battery for the current charge cycle N, α_{N} is the fade factor between the previous charge cycle (N−1) and the current charge cycle, and C_{C}(N−1) is the charge capacity of the battery for the previous charge cycle (N−1).

It is therefore clear that the fading factor gradually increases with each consecutive charge cycle. Based upon experimental data, this natural characteristic slope, or fade rate, α_{N}, is essentially constant during the life of the battery. Although high charge currents and high discharge currents cause the fading factor to initially rapidly increase, the fading factor is eventually determined by the natural characteristic slope of the battery capacity versus the number of charge cycles of the battery. That is, high charge currents and high discharge currents cause the battery to fade or become “used” faster than it would if lower charge currents and lower discharge currents were used.

In the prior art, the charge current during the constant current phase is fixed, irrespective of the state of deterioration of the battery. Usually, Lithium-ion batteries are preferably charged at a fixed charge current of 1C, where C is the rated capacity of the battery, although higher multiples of the 1C rate are also often used. If a charge rate of 1C₀ is used for a new battery, the charge rate corresponds to the ability C₀ of the battery to accept the charge.

However, if a battery has experienced numerous charge cycles, then its capacity C_{C} will be less than C₀. Therefore, a charge rate of 1C₀ will correspond to the nominal rated capacity of the battery, but will in fact be greater than the actual capacity of the battery.

For example, if α=0.8 for a particular battery, then a 1C₀ nominal rate of charge will be a 1.25C actual rate of charge for that battery.

Therefore, due to the deteriorated condition of the battery, and the inability of the battery to accept a full nominal charge, the 1C₀ charge rate will accelerate the deterioration of the charge capacity of the battery.

Therefore, the lifetime of a battery would be prolonged if the present state of deterioration of the battery could be determined and the charge rate were based upon the actual charge capacity of the battery, in its present state of deterioration, and not based upon the nominal 1C₀ rating of a new battery.

### SUMMARY OF THE INVENTION

The present invention provides a battery charger which automatically determines the ability of the battery to hold a charge, and then charges the battery at a rate commensurate with that ability. Thus, newer batteries and older batteries are charged at the same relative charging rate, but at different absolute charging rates.

The present invention provides a battery charger which decreases the rate at which the capacity of the battery fades by compensating for the decrease in the ability of the battery to hold a charge by decreasing the rate at which the battery is charged. Thus, if a battery is used and can best accept a charge at a 0.5C rate, then the battery is charged at that rate, rather than the 1C rate. The present invention thus prolongs the useful life of the battery by decreasing the charging current provided to the battery commensurate with the condition, or state of deterioration, of the battery.

This battery charger is suitable for use with various battery types, including Lithium-ion batteries. The present invention optimizes the charging process for every charge cycle during the battery's cycle life so as to minimize the fade and maximize the charge stored by the battery.

A test pulse having an amplitude (IP) and a duration (T) is applied to the battery. The battery voltages at the beginning (V₁) and at the end (V₂) of the test pulse are measured. These two voltages, and/or a difference voltage (Δ=V₂−V₁) are used to determine the state of deterioration of the battery and/or the charge capacity of the battery and/or the charging rate for charging the battery.

The present invention provides for charging a battery by applying a test pulse to the battery, measuring the battery voltage at the beginning of the test pulse, measuring the battery voltage at the end of the test pulse, optionally determining a difference voltage between the battery voltage at the beginning of the test pulse and the battery voltage at the end of the test pulse, determining a charging current level for the battery based upon the two measured voltages and/or the difference voltage, and charging the battery using that charging current level.

The present invention further provides for charging a battery by first measuring the open circuit voltage of the battery to determine if the battery has sufficient charge for further testing and, if the open circuit voltage is greater than a predetermined amount then applying a test pulse to the battery, measuring the battery voltage at the beginning of the test pulse, measuring the battery voltage at the end of the test pulse, optionally determining a difference voltage between the battery voltage at the beginning of the test pulse and the battery voltage at the end of the test pulse, determining a charging current level for the battery based upon the two measured voltages and/or the difference voltage, and charging the battery using that charging current level.

The present invention provides for determining the state of deterioration of a battery by applying a test pulse to the battery, measuring the battery voltage at the beginning of the test pulse, measuring the battery voltage at the end of the test pulse, calculating a difference voltage between the battery voltage at the beginning of the test pulse and the battery voltage at the end of the test pulse, performing a comparison of the difference voltage with a predetermined difference voltage value, and calculating the state of deterioration of the battery based upon the comparison.

The present invention also provides for determining the present capacity of a battery to store a charge by applying a test pulse to the battery, measuring the battery voltage at the beginning of the test pulse, measuring the battery voltage at the end of test charge pulse, determining a difference voltage between the battery voltage at the beginning of the test pulse and the battery voltage at the end of the test pulse, performing a comparison of the difference voltage with a predetermined difference voltage value, and calculating the present capacity of the battery based upon the comparison.

The present invention further provides for charging a battery by applying a test pulse to the battery, measuring the battery voltage at the beginning of the test pulse, measuring the battery voltage at the end of the test pulse, determining a difference voltage between the battery voltage at the beginning of the test pulse and the battery voltage at the end of the test pulse, performing a comparison of the difference voltage with a predetermined difference voltage value, calculating a charging current level for the battery based upon the comparison, and charging the battery using the charging current level.

The present invention further provides for charging a battery by first measuring the open circuit voltage of the battery to determine if the battery has sufficient charge for further testing and, if the open circuit voltage is greater than a predetermined amount then applying a test pulse to the battery, measuring the battery voltage at the beginning of the test pulse, measuring the battery voltage at the end of the test pulse, determining a difference voltage between the battery voltage at the beginning of the test pulse and the battery voltage at the end of the test pulse, performing a comparison of the difference voltage with a predetermined difference voltage value, calculating a charging current level for the battery based upon the comparison, and charging the battery using the charging current level.

The present invention also provides that the predetermined difference voltage value is the difference voltage as measured for a new battery. The present invention also provides that the predetermined difference voltage value is obtained by applying a test pulse to a new battery, measuring the battery voltage at the beginning of the test pulse, measuring the battery voltage at the end of the test pulse, and determining the predetermined difference voltage value as the difference voltage between the battery voltage at the beginning of the test pulse and the battery voltage at the end of the test pulse. The present invention further provides that the step of performing the comparison comprises reading the predetermined difference voltage value from a memory.

The present invention also provides that the state of deterioration is determined by dividing the product of a compensation factor and the difference voltage by the predetermined difference voltage value.

The present invention further provides that the present capacity of the battery is determined by calculating a fade factor determined by dividing the product of a compensation factor and the difference voltage by the predetermined difference voltage value, determining a coefficient of proportionality by subtracting the fade factor from unity, and multiplying the original capacity of the battery by the coefficient of proportionality. The present invention also provides that the charging current level for a battery is determined by determining a fade factor by dividing the product of a compensation factor and the difference voltage by the predetermined difference voltage value, determining a coefficient of proportionality by subtracting the fade factor from unity, and multiplying the original rated charge current for the battery by the coefficient of proportionality.

A test pulse having an amplitude (IP) and a duration (T) is applied to the battery. The battery voltages at the beginning (V₁) and at the end (V₂) of the test pulse are measured, and a difference voltage (ΔV) is determined. This difference voltage is used, either alone or along with the difference voltage for a new battery and a compensation factor, β, to determine the state of deterioration of the battery and/or the charge capacity of the battery and/or the charging rate for charging the battery. The state of deterioration, the charge capacity, and the charging rate may be determined by equations (algorithms) or by lookup tables.

The difference voltage and the compensation factor for a new battery are determined empirically and then stored for use in the comparison steps. Preferably, these parameters are determined for each battery type manufactured by a manufacturer, and determined separately for each manufacturer.

### BRIEF DESCRIPTION OF THE DRAWINGS

FIG. 1 is a block diagram of the preferred embodiment of the present invention.

FIG. 2 is an illustration of the waveform used to determine the state of deterioration of the battery.

FIG. 3 is a flowchart of the charging process in accordance with the present invention.

FIG. 4 is a flowchart of an alternative charging process in accordance with the present invention.

### DETAILED DESCRIPTION OF THE INVENTION

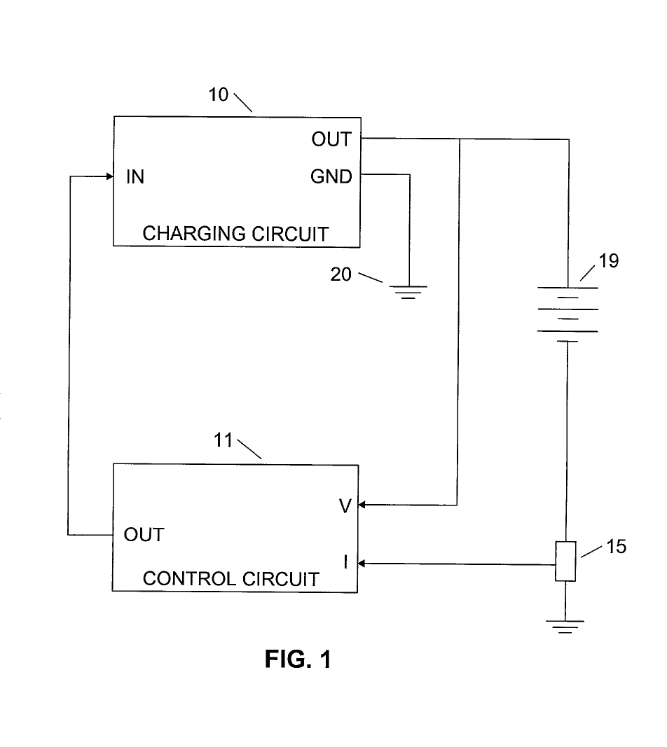

Turning now to the drawing, in which like numerals represent like components throughout the several figures, FIG. 1 is a block diagram of the preferred embodiment of the battery charger of the present invention.

The battery charger comprises a charging circuit 10, a control circuit 11, and a current sensor 15. The control circuit 11 applies a test pulse to the battery, measures the battery voltage during the test pulse, determines the state of deterioration of the battery based upon these measured voltages, determines the charge capacity of the battery, determines the appropriate charging current for the battery, and then causes the charging circuit to provide that appropriate charging current to the battery.

The control circuit 11 has a voltage input (V) connected to one terminal of the battery for receiving information about the battery voltage, and a current input (I) connected to the current sensor 15 for receiving information about the battery current. These inputs are used to control the test pulse current and measure the response of the battery to the test pulse so that the state of deterioration of the battery can be determined. The control circuit 11 controls the test pulse and any charging of the battery via the outputs (OUT) of the control circuit 11. The inputs (V, I) and outputs (OUT) of the control circuit 11 may be analog or digital, depending upon the preference of the designer. In the preferred embodiment, the control circuit 11 includes a microprocessor and an associated memory (not shown separately) for determining the state of deterioration of the battery and for setting the charging parameters for the battery so the control circuit 11 also includes appropriate analog-to-digital and digital-to-analog converters for use with the inputs and outputs.

One output terminal (OUT) of the charging circuit 10 is provided to one terminal of the battery 19, and the other output terminal (GND) is connected to the circuit ground 20. The other terminal of the battery 19 is connected through a current sensor 15 to circuit ground 20.

The current sensor 15 may be a low resistance resistor, a Hall effect device, or any other device which provides an indication of the magnitude of the current flow.

In the preferred embodiment, the memory contains the instructions, algorithms, protocols, etc., needed for controlling the microprocessor during testing and charging of the battery. If the charger is to be used for more than one battery type, the memory preferably contains information regarding charging of the different battery types to be charged using the charger. The battery 19 is charged according to the algorithm or protocol stored in the microprocessor 11 memory. The memory also has information which causes the microprocessor to provide a predetermined charging current value where initial charging of the battery is necessary prior to determination of the state of deterioration of the battery. The memory is preferably a ROM or EEPROM, but may be any convenient device, such as a disk (hard, floppy, CD-ROM, DVD-ROM), a server containing information on various battery types, or a combination of the above.

The control circuit 11 provides one or more control signals to the charging circuit 10. In the preferred embodiment, the charging circuit 10 provides for both charging pulses and depolarization pulses, and the magnitudes of those pulses may be controlled, as described in U.S. Pat. No. 5,307,000. However, if the particular charging algorithm used does not require depolarization pulses, then circuitry for that purpose may be eliminated.

The control circuit measures the battery voltage and battery current, compares this data with the data stored in the memory, or data stored in the memory for that battery type or model if more than one battery type or model is supported, and controls the charging process based upon that data and that comparison.

A typical Lithium-ion battery charging algorithm provides a constant current, then a constant voltage. The constant current phase of the charging process is maintained until the battery voltage reaches a predetermined voltage (typically 4.3V/cell). The battery voltage is preferably measured during the application of the charging current, also known as measuring the battery voltage “under current”. Once that predetermined voltage is reached the charging process enters the constant voltage phase. During this process a constant voltage is applied to the battery voltage and the current is measured. Various criteria are used in the art to determine when to terminate the charging process. For example, the battery open circuit voltage or the battery charging current, or both, are compared with predetermined termination values, which are stored in the memory.

Thus, the embodiment of FIG. 1 determines the state of deterioration of the battery, determines the actual charge capacity of the battery and the appropriate charging current, and then charges the battery accordingly.

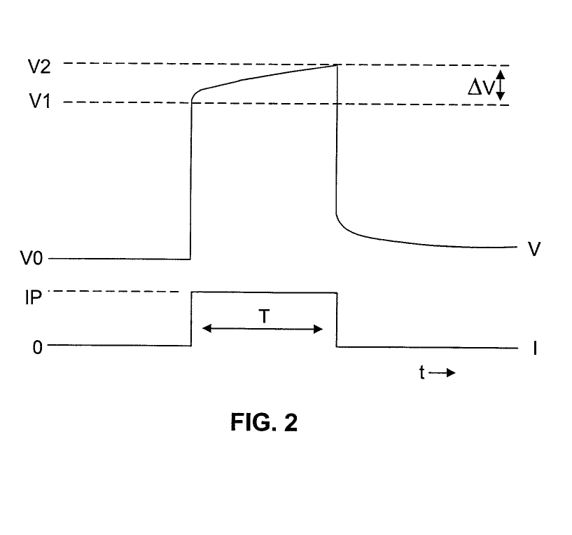

FIG. 2 is an illustration of the waveform used to determine the state of deterioration of the battery. First, the state of charge of the battery is determined by measuring the open circuit voltage (V₀) of the battery. If V₀ is greater than a predetermined amount (V_{MIN}), then the state of charge of the battery is adequate for testing to determine the actual charge capacity of the battery. In the preferred embodiment, for Lithium-ion batteries, V_{MIN} is 3.5 volts per cell. The value of V_{MIN} is not critical and has been determined empirically. If V_{MIN} is too low then the state of deterioration tests will not be as accurate. If V_{MIN} is too high then excessive preliminary charging of the battery may occur before the state of deterioration test is performed.

If V₀ is less than V_{MIN}, then the battery charge level is too low and a preliminary charge is provided to the battery. In the preferred embodiment, the preliminary charge is approximately 5% of the rated capacity of the battery. For example, charging at a rate of approximately 0.5C for approximately 6 minutes (0.5C*6 minutes/1C=5%). These values are not critical. Other preliminary charge amounts may be used and different charging rates and charging times may be used. However, too low a value for the preliminary charge may not increase the state of charge of the battery to an adequate level for testing, and too high a value for the preliminary charge may exceed the charge capability of the battery or otherwise degrade the performance, testing, or cycle lifetime of the battery.

After the preliminary charge the battery is allowed to rest or relax for approximately one minute so as to achieve a state close to electrochemical equilibrium. This rest or relaxation period is not critical but too short a rest period may cause erroneous test results as the battery may not have reached electrochemical equilibrium, whereas too long a rest period unnecessarily delays the testing and charging processes.

After the preliminary charge and rest period, the open circuit voltage is measured again. If it is now above V_{MIN} then further testing and charging can proceed. If it is still below V_{MIN} then the process may be terminated or, if there has been a noticeable increase in the open circuit voltage, then the battery may have been severely discharged and another preliminary charge may be applied.

If the open circuit battery voltage is at least V_{MIN}, then the state of deterioration can be determined. A current test pulse, preferably having a rectangular (constant current) waveform, an amplitude IP, and a duration T, is applied to the battery. The battery voltage (V₁) is measured under current at the beginning of the test pulse, and the battery voltage (V₂) is measured again, still under current, at the end of the test pulse.

The polarization of the battery is then estimated by subtracting either V₀ or V₁ from V₂. The first difference voltage (V₂−V₀) includes both the Ohmic (IR) voltage drop (V₁−V₀) due to the internal resistance of the battery, and the polarization voltage drop (V₂'V₁). The second difference voltage (V₂−V₁, or ΔV) represents only the battery polarization voltage drop component. In the preferred embodiment, the second difference voltage ΔV is used to determine the state of deterioration of the battery because it is a more accurate indicator of the state of deterioration.

For a given amplitude IP for a test pulse, if the battery is seriously deteriorated, that is, the state of deterioration is higher, then the internal impedance of the battery will also be higher and, accordingly, the polarization voltage drop ΔV will be higher.

It will be appreciated that the internal impedance of the battery may also be determined by dividing the battery voltage under current by the battery current during a charging pulse. The value (V₀−V₂)/I yields the magnitude of the battery impedance vector, which includes both electrical (Ohmic) and ionic (Polarization) components of the battery impedance. However, the value ΔV/I yields only the ionic impedance component of the battery impedance which causes the battery polarization. However, determining the battery impedance in this manner as a step to determining the appropriate charging current for the battery requires a division operation and, for speed and efficiency of operation of the microprocessor in the control circuit 11, division operations are preferably avoided. In the preferred embodiment, division operations are avoided by using the ΔV parameter as an index to a lookup table for determining the appropriate charging current and, if desired, the present value of the battery impedance.

The appropriate charge current I_{c} is a approximately a linearly declining function of the battery polarization voltage ΔV. Therefore, in the preferred embodiment, the lookup table is created empirically using experimental ΔV data for a fresh (Δ=1) battery and experimental ΔV data for a cycled battery with a fade factor α=0.75. For speed, simplicity, and efficiency, only these values are stored and the measured Δvalue for the battery under test is used to linearly interpolate between these two points to determine the fade factor, the appropriate charging current, the battery impedance, etc. It is also possible to use a table with a larger number of values and to use the value or set of values which for that measured ΔV or the nearest ΔV to the measured ΔV. Equations may also be used if desired. The number of experimental points in the table is not critical. More points provide more accurate settings, but fewer points use less memory and are generally adequate for most charging situations.

The lower fade factor value, α=0.75, was selected because a fade factor below this level is considered by the inventors to indicate a battery in poor condition, i.e., a bad battery. However, in other situations, or where replacement of the battery is difficult, expensive, or impossible, or on a replacement schedule, then it may be desirable extend the table or equations to lower fade factor values, the lower limit being determined by the particular situation, so that the appropriate charge current for even a “bad” battery can be determined and used so as to prolong the remaining useful life of that “bad” battery, even if the battery has substantially deteriorated.

Preferably, the amplitude IP of the current test pulse is selected to provide a charge rate within the range of 0.5C to 2C, with a duration within the range of 10 to 60 seconds, to provide a charge of less than 0.05C. This value is not critical, but too large a value could damage a battery which already had a full charge, and too small a value could yield incorrect test results. In the preferred embodiment, for example, a test pulse of 0.5C for 30 seconds provides a charge which is 0.42% of the nominal full charge rating for a new battery.

When measuring V₁ and V₂, it is easy to ascertain those points visually on a waveform. However, the control circuit 11 does not have that luxury. However, the control circuit 11 knows when it begins a test pulse and when it is about to terminate the test pulse, so V₁ is determined by measuring the battery voltage immediately after the test pulse is applied, and V₂ is determined by measuring the battery voltage immediately prior to termination of the test pulse.

Other ways of determining the voltage V₁ may also be used. However, consideration should be given to the fact that the voltage V₁ is on the rising edge of the test pulse and a voltage measurement at the beginning of the rising edge of the voltage would be significantly less than a voltage measurement at the end of the rising edge. Therefore, as stated above, V₁ may be determined by measuring the battery voltage a predetermined time after the start of the test pulse, for example, 10 milliseconds. Another method of determining when to measure V₁ is to use the battery voltage after the “knee” of the battery voltage. The slope of the battery voltage up to the knee will be rapid, and will then be significantly less. Therefore, the slope of the battery voltage may be measured and the battery voltage measurement taken after the slope has fallen below a predetermined value. Other methods of measuring V₁ and V₂ may also be used, such as by periodically sampling the battery voltage during the application of the test pulse and then selecting the highest value for V₂ and a value after the rising edge of the pulse for V₁.

Although the battery voltage shown in FIG. 2 is a smooth line, the actual battery voltage may have a significant amount of “noise” on it. The effect of the noise may be eliminated by using a low pass filter or by using an average of several voltage measurements, or both.

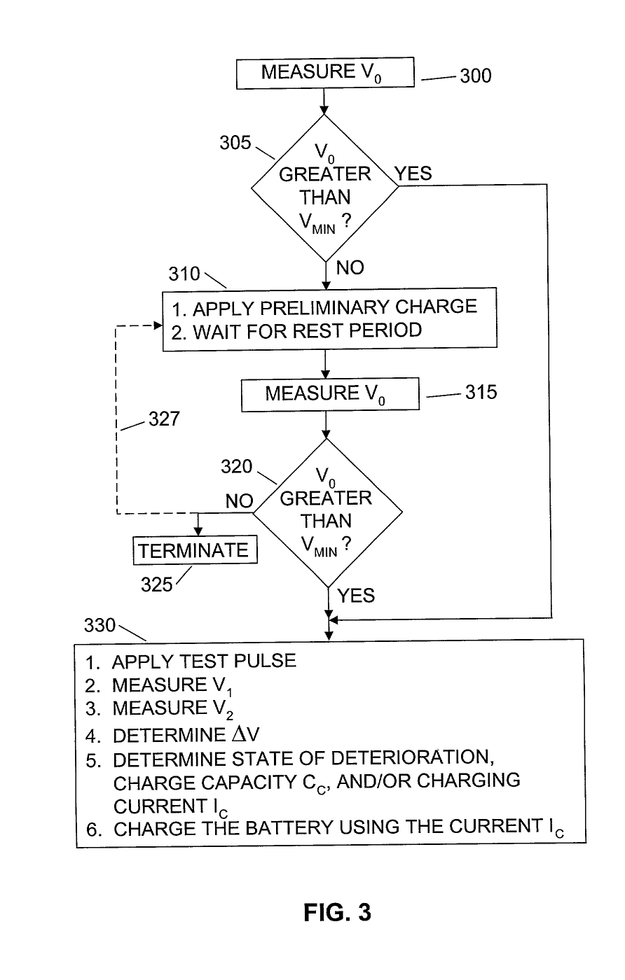

FIG. 3 is a flowchart of the preferred process for determining the state of charging current, charge capacity, or state of deterioration of the battery. This process, and the subsequent charging process, are preferably implemented by the control circuit 11. It has been found experimentally that the polarization voltage drop ΔV, for practical purposes, does not depend on the battery state of charge if the state of charge is within the range of 5% to 50%. If the state of charge is less than 5%, then the polarization of the battery increases significantly and it is more difficult to estimate the state of deterioration of the battery based only on the polarization voltage. Thus, in the preferred embodiment, before measuring the state of deterioration of the battery, the state of charge of the battery is measured to determine if the state of deterioration test will be accurate. In step 300, the open circuit voltage V₀ of the battery is measured.

In step 305 V₀ is compared with a predetermined minimum value V_{MIN}, which is preferably stored in the memory in the control circuit 11. If V₀ is greater than V_{MIN}, the battery is sufficiently charged for testing and step 330 is executed.

If V₀ is less than V_{MIN}, then in step 310 a preliminary charge and then a relaxation period, as described above, are applied to the battery. After the relaxation period, V₀ is measured again in step 315, and then compared with V_{MIN}, in step 320. If V₀ is now greater than V_{MIN}, then step 330 is executed. However, if V₀ is still less than V_{MIN}, then the battery may be bad or improperly connected, so testing is terminated and a notice is sent to the operator, such as by an visual or audible alarm or indicator, or a printout, or a combination of two or more such methods.

Optionally, as indicated by dashed line 327, at step 320, if V₀ is still less than V_{MIN}, a return may be made to step 310 so that the preliminary charge may be repeated up to a predetermined number of times before testing is terminated.

In the preferred embodiment, the test pulse of FIG. 2 is applied, voltages V₁ and V₂ are measured, the polarization voltage drop ΔV is calculated as V₂−V₁, which reflects the polarization level of the battery, which is directly indicative of the state of deterioration of the battery, and the corresponding state of deterioration, charge capacity, and/or charge current are read from a lookup table or calculated from an equation using the difference voltage ΔV as the measured variable. Alternatively, rather than determining the voltage drop (difference voltage) ΔV, one can use the measured voltages V₁ and V₂ to directly enter a lookup table or algorithm.

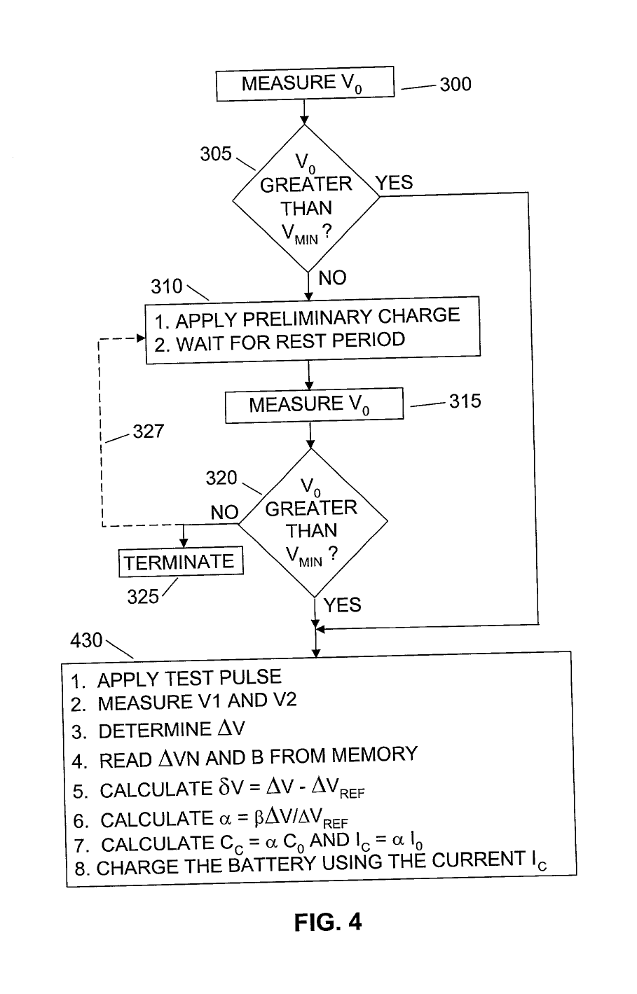

FIG. 4 is a flowchart of an alternative process for determining the state of charging current, charge capacity, or state of deterioration of the battery. Steps 300 through 325 are the same as for FIG. 3. However, in step 430, the test pulse of FIG. 2 is applied, voltages V₁ and V₂ are measured, the polarization voltage drop ΔV is calculated as V₂−V₁, which reflects the polarization level of the battery, which is directly indicative of the state of deterioration of the battery, and the parameters β and ΔN are read from the memory. The difference δV between the measured polarization drop ΔV for the battery under test and the polarization voltage drop ΔV_{REF} for a new battery is determined, and the state of deterioration or the fade factor α, the appropriate charging current I_{C} for the battery, and/or the remaining charge storage capacity of the battery C_{C}, are determined. Finally, the battery is charged based on the appropriate charging current. Alternatively, rather than determining the voltage drop (difference voltage) ΔV, one can use the measured voltages V₁ and V₂ to directly enter a lookup table or algorithm.

With respect to FIGS. 1-4, the more the battery is used (cycled), the higher the internal impedance of the battery will be, and, as a consequence, the higher will be the polarization voltage drop ΔV for a given test current pulse.

Also, as previously stated, the ΔV value for a new battery (ΔV_{REF}) is determined empirically, and is preferably stored in the memory in the control circuit 11. It is important to note that the stored value ΔV_{REF} should be for a new battery and obtained using a current test pulse with a predetermined amplitude and duration, and that the test pulse used to determine the state of deterioration of the battery under test should preferably have an identical amplitude and duration. The more the test pulse for the battery under test differs from the test pulse used to determine ΔV_{REF}, the less accurate the results will be.

Using this value ΔV_{REF} in step 330 the difference δV between the polarization voltages for the battery under test and a new battery is:

δV=ΔV−ΔV_{REF}

The charging current I_{C} is then calculated as:

I_{C}=I₀(1−ΔV_{REF})

where I_{C} is the calculated charging current, I₀ is the charging current appropriate for a new battery, and β is a compensation factor for the particular brand or model. The parameters ΔV_{REF} and β are read from the memory. Although the above described the theoretical basis for determining the appropriate charging current, in the preferred embodiment, the appropriate charging current I_{C} is determined, as stated above, by reading a value from a table in memory, or by using an equation, based upon using the measured ΔV value as an index or an address into the table or as a supplied variable in an equation.

Not all batteries are created equal. For example, a battery created by one manufacturer may have different characteristics than another manufacturer, even if both batteries carry the same type designation. As another example, a manufacturer may have a low-cost (home) line and a higher-cost (professional) line for the same battery type. Thus, the polarization voltage drop may be different, even for new batteries. Therefore, a compensation factor β is included to account for these differences. This compensation factor β is also determined empirically and is preferably stored in the memory for several different battery types and manufacturers. However, if the charger is to be used for only one battery type and one manufacturer then only the compensation factor for that battery type is stored in the memory.

It will be recalled that C_{C}=αC₀, and also that

I_{c}=I₀(1−βδV/ΔV_{REF})

It will be recalled that, to minimize high current polarization effects, the charging current I for the battery should be based upon the charge capacity C of the battery. Thus, to maintain the C-rate of charge of the battery as constant regardless of the capacity fade, the charge current I_{c} for a cycled battery must be chosen in accordance with the expression

I_{c}=αI_{REF}

Comparing this formula with the previous expression results in:

α=(1−βδV/ΔV_{REF})

Therefore, solving for β yields:

β=(1−α) ΔV_{REF}/δV

Therefore, if the coefficient β has been chosen in accordance with the above, then the rate of charge of the battery will be maintained at the same C-rate level during the battery cycle life despite the existing capacity fade. Therefore, the battery will not be charged at a rate higher than the rate that it can accept, and the disadvantages and adverse effects of the various prior art chargers is avoided.

For example, based on experimental data for the Motorola StarTAC™ cellular phone in which a Lithium-ion battery with a rated capacity (C) of 900 mAh is used, a new battery had a capacity of 900 mAh, and a battery cycled 500 times had only a capacity 670 mAh. Thus, for that type of battery, α=675/900=0.75. Thus, the fade factor is 0.75, that is, the residual battery capacity is 75% of its original value, or, in other words, 25% of the original battery capacity has been lost. A current test pulse with amplitude 1A and duration 60 s was used, and a value of 1.68 was then calculated for the ratio δV/ΔV_{REF}. Substituting these data provides the result β=0.15.

Given that the charging current I₀ for a new battery of this type is 900 mA, then, in the case of this cycled battery in its current state of deterioration (25% deteriorated), the proper charging current for a charge rate of 1C′ (the deteriorated charge capacity) will be:

I_{c}=I₀(1−βδV/ΔV_{REF})

I_{c}=0.9*(1−0.15*1.68)=0.75*0.9=675 mA.

Thus, this worn battery, with its reduced residual capacity 1C′ of 675 mAh, will be charged at its new 1C′ rate, thus avoiding the adverse effects of charging the battery at a rate higher than its reduced 1C′ rate.

Once the state of deterioration of the battery has thus been determined, and the proper charging current has been calculated, the battery can be charged using any desired charging method, such as that disclosed in U.S. Pat. No. 5,307,000, which discloses a repeating cycle of using one or more charge pulses, followed by two or more depolarization pulses, with rest periods interspersed thereinbetween.

Therefore, the present invention solves the problem that occurs from attempting to charge a used (cycled) battery using the charge parameters appropriate for a new battery. The present invention determines the state of deterioration of the battery, the maximum charge that it can accept, and/or the rate at which it can accept a charge, and then charges the battery at the rate and to the level appropriate for that battery in its current condition. The present invention therefore customizes the charging process for the battery to be charged and avoids the degradation caused by attempting to charge the battery at a rate higher than it can accept or to a level higher than its current capacity.

Although the present invention has been described with respect to a 1C charge rate, some battery types accept much higher charge rates, for example, 5C, without experiencing increased fading effects. Therefore, if a particular type or model of a battery can accept a 5C charge rate without being subject to an increased fade factor, then this higher charge rate will be used but will be scaled down proportionally as the battery is used. For example, a particular type and model of a battery may accept a charge rate of up to 5C without increased fading. Therefore, charging for a new battery may be at 5C. However, as the battery ages or is used, the charge capacity of the battery may fall to 0.8*C₀. Therefore, the new charging rate for this battery would become 4*C₀(0.8*5C₀), but the new charge capacity of that battery is now only 4, so the 4 charge rate is actually a 5C charge rate for the battery under test. Therefore, it should be understood that the present invention is contemplated for use with charging currents in excess of 1C₀.

Although the present invention has been described with respect to use with Lithium-ion batteries, the present invention is not so limited and may be used with many different battery types, such as, for example, NiCd, NiMH, and Lead-acid. Not all possible battery types have been listed or tested. However, based upon the disclosure above, one of ordinary skill in the art would test the present invention for use with other types of batteries as the need to use other battery types arises. Therefore, the present invention is to be limited only by the claims below.

We claim:

1. A method for determining the condition of a battery, comprising the steps of:
applying a test pulse to said battery;
measuring the battery voltage at the beginning of said test pulse;
measuring the battery voltage at the end of said test pulse; and
using said battery voltage at the beginning of said test pulse and said battery voltage at the end of said test pulse to determine at least one of the following conditions of said battery: a state of deterioration of said battery, a charge capacity for said battery, and an appropriate charging current for said battery.

2. The method of claim 1 wherein said step of using said battery voltage at the beginning of said test pulse and said battery voltage at the end of said test pulse comprises:
determining a difference voltage between said battery voltage at the beginning of said test pulse and said battery voltage at the end of said test pulse; and
using said difference voltage to determine said at least one condition of said battery.

3. The method of claim 2 wherein said step of using said difference voltage comprises:
performing a comparison of said difference voltage with a predetermined difference voltage value; and
using said comparison to determine said at least one condition of said battery.

4. The method of claim 3 wherein said predetermined difference voltage value is the difference voltage for a new battery.

5. The method of claim 3 wherein said predetermined difference voltage value is obtain by the steps of:
applying a test pulse to a new battery;
measuring the battery voltage at the beginning of said test pulse;
measuring the battery voltage at the end of said test pulse; and
determining said predetermined difference voltage value as the difference voltage between said battery voltage at the beginning of said test pulse and said battery voltage at the end of said test pulse.

6. The method of claim 3 wherein said step of performing said comparison comprises reading said predetermined difference voltage value from a memory.

7. The method of claim 3 wherein said step of determining said at least one condition comprises dividing the product of a compensation factor and said difference voltage by said predetermined difference voltage value.

8. The method of claim 3 wherein said step of determining said at least one condition comprises determining said charge capacity of said battery by:
determining a fade factor by dividing the product of a compensation factor and said difference voltage by said predetermined difference voltage value;
determining a coefficient of proportionality by subtracting said fade factor from unity; and
multiplying the original charge capacity of said battery by said coefficient of proportionality.

9. The method of claim 3 wherein said step of determining said at least one condition comprises determining said appropriate charging current of said battery by:
determining a fade factor by dividing the product of a compensation factor and said difference voltage by said predetermined difference voltage value;
determining a coefficient of proportionality by subtracting said fade factor from unity; and
multiplying the original rated charging current of said battery by said coefficient of proportionality.

10. The method of claim 1 and, prior to said step of applying said test pulse to said battery, further comprising the steps of:
measuring the open circuit voltage of said battery;
if said open circuit voltage is greater than a predetermined amount then proceeding to said step of applying said test pulse of said battery.

11. The method of claim 1 and, prior to said step of applying said test pulse to said battery, further comprising the steps of:
measuring the open circuit voltage of said battery;
if said open circuit voltage is less than a predetermined amount then said test pulse is not applied to said battery.

12. The method of claim 1 wherein said step of using said battery voltage at the beginning of said test pulse and said battery voltage at the end of said test pulse comprises using said battery voltage at the beginning of said test pulse and said battery voltage at the end of said test pulse to obtain said at least one condition from one of a table or an equation.

13. The method of claim 1 wherein said step of using said difference voltage comprises using said difference voltage to obtain said at least one condition from one of a table or an equation.

14. A method for charging a battery, comprising the steps of:
measuring the open circuit voltage of said battery;
if said open circuit voltage is greater than a predetermined amount then:
applying a test pulse to said battery;
measuring the battery voltage at the beginning of said test pulse;
measuring the battery voltage at the end of said test pulse;
using said battery voltage at the beginning of said test pulse and said battery voltage at the end of said test pulse to determine an appropriate charging current for said battery; and
charging said battery using said appropriate charging current.

15. The method of claim 14 wherein said step of using said battery voltage at the beginning of said test pulse and said battery voltage at the end of said test pulse comprises determining a difference voltage between said battery voltage at the beginning of said test pulse and said battery voltage at the end of said test pulse; and
using said difference voltage to determine said appropriate charging current.

16. The method of claim 14 wherein said step of using said difference voltage comprises:
performing a comparison of said difference voltage with a predetermined difference voltage value; and
using said comparison to determine said appropriate charging current.

17. The method of claim 15 wherein said predetermined difference voltage value is the difference voltage for a new battery.

18. The method of claim 16 wherein said predetermined difference voltage value is obtain by the steps of:
applying a test pulse to a new battery;
measuring the battery voltage at the beginning of said test pulse;
measuring the battery voltage at the end of said test pulse; and
determining said predetermined difference voltage value as the difference voltage between said battery voltage at the beginning of said test pulse and said battery voltage at the end of said test pulse.

19. The method of claim 16 wherein said step of performing said comparison comprises reading said predetermined difference voltage value from a memory.

20. The method of claim 15 wherein said step of determining an appropriate charging current level for said battery comprises:
determining a fade factor by dividing the product of a compensation factor and said difference voltage by said predetermined difference voltage value;
determining a coefficient of proportionality by subtracting said fade factor from unity; and
multiplying the original rated charging current for said battery by said coefficient of proportionality.

21. The method of claim 14 wherein said step of using said battery voltage at the beginning of said test pulse and said battery voltage at the end of said test pulse comprises using said battery voltage at the beginning of said test pulse and said battery voltage at the end of said test pulse to obtain said at least one condition from one of a table or an equation.

22. The method of claim 15 wherein said step of using said difference voltage comprises using said difference voltage to obtain said at least one condition from one of a table or an equation.

23. A method for determining the condition of a battery, comprising the steps of:
applying a test pulse to said battery;
measuring the battery voltage at the beginning of said test pulse;
measuring the battery voltage at the end of said test pulse;
determining a difference voltage between said battery voltage at the beginning of said test pulse and said battery voltage at the end of said test pulse;
performing a comparison of said difference voltage with a predetermined difference voltage value; and
using said comparison to determine at least one of the following conditions of said battery: a state of deterioration of said battery, a charge capacity for said battery, and an appropriate charging current for said battery.

24. A battery tester, comprising:
a charging circuit connected to a battery and responsive to a control signal for applying a test pulse to said battery; and
a control circuit functionally connected to said charging circuit and to said battery, said control circuit causing said charging circuit to apply said test pulse, measuring the voltage of said battery at the beginning of said test pulse and at the voltage of said battery at the end of said test pulse, and determining at least one of the following conditions of said battery based upon said voltage of said battery at the beginning of said test pulse and said voltage of said battery at the end of said test pulse: a state of deterioration of said battery, a charge capacity for said battery, and an appropriate charging current for said battery.

25. The battery tester of claim 24 wherein said control circuit comprises means for determining a difference voltage between said battery voltage at the beginning of said test pulse and said battery voltage at the end of said test pulse, and using said difference voltage to determine said at least one condition.

26. The battery tester of claim 24 wherein said control circuit comprises means for determining a difference voltage between said battery voltage at the beginning of said test pulse and said battery voltage at the end of said test pulse, performing a comparison of said difference voltage with a predetermined difference voltage value, and using said comparison to determine said at least one condition.

27. A battery charger, comprising:
a charging circuit connected to a battery and responsive to a control signal for applying a test pulse to said battery and for applying charging pulses to said battery; and
a control circuit functionally connected to said charging circuit and to said battery, said control circuit causing said charging circuit to apply said test pulse, measuring the voltage of said battery at the beginning of said test pulse and at the end of said test pulse, and determining an appropriate charging current for said battery based upon said voltage of said battery at the beginning of said test pulse and at the end of said test pulse, and causing said charging circuit to apply said charging pulses to said battery, said charging pulses providing said appropriate charging current for said battery.

28. The battery tester of claim 27 wherein said control circuit comprises means for determining a difference voltage between said battery voltage at the beginning of said test pulse and said battery voltage at the end of said test pulse, and using said comparison to determine said appropriate charging current.

29. The battery tester of claim 27 wherein said control circuit comprises means for determining a difference voltage between said battery voltage at the beginning of said test pulse and said battery voltage at the end of said test pulse, performing a comparison of said difference voltage with a predetermined difference voltage value, and using said comparison to determine said appropriate charging current.
